(19) United States
(12) Patent Application Publication
(10) Pub. No.: US 2006/0135013 A1
(43) Pub. Date: Jun. 22, 2006

(54) Hot press-bonding type label or mark having its base sheet made of non-woven fabric, taffeta, spongy material or the like

(76) Inventors: Shigeji Higashiguchi, Tokyo (JP); Shinichi Nagai, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/284,900

(22) Filed: Nov. 23, 2005

(30) Foreign Application Priority Data
Nov. 25, 2004 (JP) 2004-340182

(51) Int. Cl. B32B 27/04; B32B 7/12

(52) U.S. Cl. 442/150; 428/354; 428/346

(57) ABSTRACT

In a hot press-bonding mark: the mark has a base sheet made of a non-woven fabric, a taffeta, a spongy material or the like; a thin film of a thermoplastic synthetic resin excellent in printability in an ink-jet or an ink-ribbon printing system is formed in one of opposite surfaces of the base sheet; an intermediate layer constructed of a thin film of a thermoplastic synthetic resin which does not react on any release agent is formed in the other of the opposite surfaces of the base sheet to leave the other of opposite surfaces of the intermediate layer alone; and, an adhesive layer comprising a hot-melt based thermoplastic synthetic resin is formed in the thus left-alone one of the opposite surfaces of the intermediate layer. If necessary, it is possible to peel off the mark from a uniform and like objects to which the mark is applied.

### BACKGROUND OF THE INVENTION

1. Field of the Invention

The present invention relates to a hot press-bonding type textile article or label, which label is hereinafter referred to as “mark” and has its base sheet made of a soft non-woven fabric, taffeta, spongy material or the like.

2. Description of the Related Art

A conventional hot press-bonding type of a label or mark has its base sheet made of a woven fabric and/or a knitted textile. A layer of a hot-melt adhesive made of a thermoplastic synthetic resin is applied to this base sheet to form a mark cloth. The thus formed mark cloth is then cut into a piece of desired shape to prepare a piece of a desired label or mark, which carries characters, letters, graphics or like designs. In order to produce the mark cloth, various kinds of researches have been conducted in selecting both its base sheet and the hot-melt based thermoplastic synthetic resin of the adhesive layer of the mark cloth with the consideration for a user's uniform or like objects to which the desired mark is applied. More recently, in addition to the researches in developing the mark cloth suitable for application to the user's uniform or like objects to which the mark is applied, another research has been also conducted in finding out a suitable method for neatly peeling off the mark from the user's uniform or like objects after use. As for the former researches and development of the mark cloth, the inventors of the present invention have proposed their technical ideas in Japanese Patent No. 2675326. As for the latter research and development of the suitable method for neatly peeling off the mark from the user's uniform or like objects after use, the inventors of the present invention have proposed their technical ideas in Japanese Patent application Laid-open Nos.: 2004-100050 and 2004-174458.

It is also proposed in the prior art to use the woven fabric and/or knitted textile as the base sheet of the mark cloth of hot press-bonding type. On the other hand, as for a non-woven fabric, since the non-woven fabric tends to fray in fiber in use, there had been substantially no product of a mark cloth employing the non-woven fabric as its base sheet on the market until now. However, recently the non-woven fabric is accelerated in the pace of researches and development thereof. For example, there has been developed a non-woven fabric called “Span-lace” (trade name) in the prior art. The Span-lace is one of textile products, which are commercially available from a Japanese company called “Mitsubishi Seishi Kabushiki Kaisha”. In appearance, the Span-lace is thin in thickness as is in the Japanese paper called “Washi”, and good both in fraying-resisting properties and in texture. The Span-lace is soft in feeling. Although such a non-woven fabric such as the Span-lace has many advantages as described above, the non-woven fabric is basically poor in printability with respect to an ink-jet printing system and an ink-ribbon printing system, as is in the case of each of the other materials such as taffeta, spongy material and the like.

Consequently, there is not provided at all any ideal mark cloth in the prior art, wherein the ideal mark cloth has its base sheet constructed of a non-woven fabric, taffeta, spongy material or the like having been printed by any one of the above-mentioned printing systems.

### SUMMARY OF THE INVENTION

Under such circumstances, the present invention was made. Consequently, it is an object of the present invention to provide a hot press-bonding type “mark”, which is cut out of a mark cloth and has its base sheet made of a non-woven fabric, taffeta, spongy material or the like which is excellent in texture, particularly, in softness in feeling, wherein the mark is excellent in printability in use and also excellent in separability (i.e., peelability) from the user's uniform or like objects after use, to which uniform or like objects the mark is applied or bonded in use.

In accordance with the present invention, the above object of the present invention is accomplished by providing:

A hot press-bonding mark having a construction characterized in that: the mark is provided with a base sheet made of a non-woven fabric, a taffeta, a spongy material or the like; a thin film of a thermoplastic synthetic resin excellent in printability in an ink-jet printing system or in an ink-ribbon printing system is formed in one of opposite surfaces of the base sheet; an intermediate layer constructed of a thin film of a thermoplastic synthetic resin which does not react on any release agent is formed in the other of the opposite surfaces of the base sheet to leave the other of opposite surfaces of the intermediate layer alone; and, an adhesive layer comprising a hot-melt based thermoplastic synthetic resin is formed in the thus left-alone one of the opposite surfaces of the intermediate layer.

Since the mark of the present invention has the above construction, it is possible for a user of the mark to apply or bond the mark onto his or her uniform or like objects to which the mark is applied or bonded in use.

Although the base sheet of the mark is made of a non-woven fabric, a taffeta, a spongy material or the like which is poor in printability in the ink-jet or the ink-ribbon system, it is possible for the user to print his or her favorite ones of characters, letters, graphics and like designs on his or her uniform or like objects without any trouble in use.

Further, if necessary, it is possible for the user to neatly peel off the mark from his or her uniform and like objects without any trouble.

### BRIEF DESCRIPTION OF THE DRAWING

The above and other objects, advantages and features of the present invention will be more apparent from the following description taken in conjunction with the accompanying drawing in which:

FIG. 1 is a perspective view of the mark having a construction of the present invention.

### DETAILED DESCRIPTION OF THE PREFERRED EMBODIMENTS

The best modes for carrying out the present invention will be described in detail using embodiments of the present invention with reference to the accompanying drawing.

The present invention may, however, be embodied in various different forms and should not be construed as limited to the embodiments set forth herein; rather, these embodiments are provided so that this disclosure will be thorough and complete, and will fully convey the scope of the present invention to those skilled in the art.

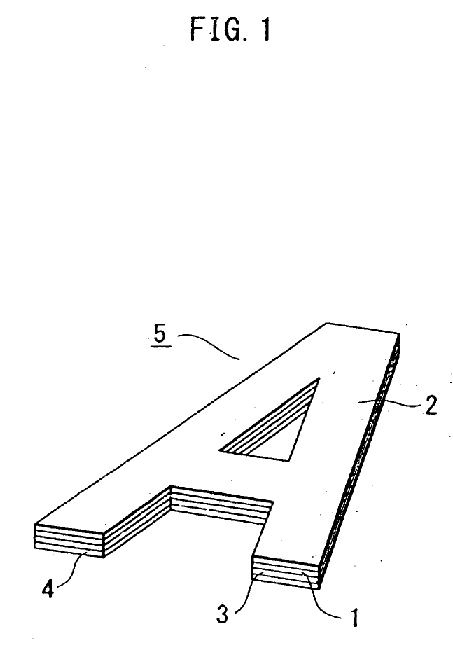

In FIG. 1, the reference numerals 1, 2, 3, 4 and 5 denote the following essential parts of a mark having a construction of the present invention, as follows: 1 denotes a base sheet of the mark of the present invention, the base sheet 1 being made of a selected one of materials comprising a non-woven fabric, a taffeta, a spongy material or the like; 2 denotes a thin film or layer of a synthetic resin excellent in printability; 3 denotes an intermediate layer constructed of a thin film of a synthetic resin, which does not react on any release agent; 4 denotes an adhesive layer comprising a hot melt-based thermoplastic synthetic resin in composition; and, 5 denotes a piece of mark having a construction of the present invention.

As described above, in construction, the mark 5 of the present invention has its base sheet 1 made of a selected one of materials comprising a non-woven fabric, a taffeta, a spongy material or the like. An example of such a non-woven fabric used in the mark 5 of the present invention is “Span-lace” (trade name), which is one of non-woven products commercially available from a Japanese company called “Mitsubishi Seishi Kabushiki Kaisha”. This non-woven product “Span-lace” is thin in thickness as is in the Japanese paper “Washi”. Further, this non-woven product “Span-lace” is soft in texture and excellent in resistance to fraying in use. It is also possible to use any other non-woven product as the base sheet of the mark of the present invention, provided that such other product shows the same level of performance as that of the “Span-lace”. The base sheet 1 of the mark will be hereinbelow described in detail.

First, the performance of the non-woven fabric or product described above is considered as a point to the present invention. In accordance with the present invention, the thin layer 2 of the synthetic resin is excellent in printability in the ink-jet or the ink-ribbon printing system, and is formed in one of opposite surfaces of the base sheet 1 made of the non-woven fabric by applying a solvent-based thermoplastic resin to the surface of the base sheet 1 through a coating process using such a solvent-based thermoplastic resin, or by laminating a thin film of a thermoplastic synthetic resin to the surface of the base sheet 1 through a laminating process.

After that, the thin film 3 made of the thermoplastic synthetic resin, which does not react on any release agent, is formed as the intermediate layer 3 on the other of the opposite surfaces of the base sheet 1.

Formed so as to be disposed adjacent to the thus formed intermediate layer or thin film 3 is the adhesive layer 4 which is made of the hot-melt based thermoplastic synthetic resin and has its lower surface left alone, as viewed in FIG. 1.

Then, the thus left-alone lower surface of the adhesive layer 4 is backed with a release paper (not shown).

The thin film formed as the intermediate layer 3 made of the thermoplastic synthetic resin, which does not react on any release agent, in the construction of the mark 5 of the present invention may be formed from the user's uniform or like object itself, to which object the mark is applied or bonded. Alternatively, the intermediate layer 3 may be made of a thermoplastic synthetic resin, which also does not react on any release agent, and comprise a pigment for partially dying the user's uniform or like objects to which the mark is applied. Furthermore, with respect to the intermediate layer 3, it is also possible to add any anti-transparency agent to the thermoplastic synthetic resin of the intermediate layer 3 in order to prevent the design or the user's uniform or like objects in shape from being observed from outside, wherein the anti-transparency agent is effective to prevent the design of the user's uniform or like objects in shape from being observed from outside even when the design of the user's uniform or like objects is dyed using a sublimation type pigment and the pigment sublimates in use.

The cloth for the mark, that is, the mark cloth is prepared according to the present invention as described above.

After the mark cloth is prepared, a desired one of designs, patterns, characters, letters, graphics or the like is printed on the mark cloth in the ink-jet or the ink-ribbon printing system using a selected one of inks which have an affinity for the thin film 2 of the mark cloth, which film 2 is made of the synthetic resin excellent in printability. After completion of printing process of the mark cloth with the desired pattern or the like, the mark cloth thus printed is subjected to an ink drying process.

Through the above-mentioned processes, preparation of the mark cloth of the present invention is completed, wherein the desired pattern or the like is printed on the thin film 2 of the printable synthetic resin formed on the surface of the non-woven fabric forming the base sheet 1 of the mark cloth according to the present invention.

The thus completed mark cloth is then cut into a desired shape to form a piece of “mark” 5 assuming such a desired shape.

Application of the mark 5 onto the user's uniform or like objects is performed in a conventional or known method, as follows: first, the release paper (not shown) of the mark 5 is peeled off from the body of the mark 5. After that the mark 5 has its hot-melt based adhesive layer 4 disposed adjacent to a desired portion of the user's uniform or like objects which has been previously disposed on an ironing pad or the like. Then, heat energy is applied to the mark 5 at a temperature slightly higher than a melting point of the adhesive layer 4 for a period of time required for melting the adhesive layer 4 to melt the adhesive layer 4 using a heating press machine, for example such as a domestic electric iron or the like.

Through this hot pressing operation conducted using the heating press machine, the adhesive layer 4 of the mark 5 is melt to enter a space formed between fibers of a cloth of the user's uniform or like objects, to which the mark 5 should be applied or bonded. On the other hand, the thus melt synthetic resin of the adhesive layer 4 adheres also to the intermediate layer 3 which is formed from the thin film of the synthetic resin and does not react on any release agent. Since the synthetic resin of the intermediate layer 3 is not made of any hot-melt based thermoplastic resin, there is no fear that the intermediate layer 3 of the mark 5 is melt during the hot pressing operation of the mark 5.

As described above, it is possible to apply or bond the mark 5 of the present invention onto the user's uniform or like objects through the above-mentioned processes.

In the mark 5 bonded to the user's uniform or like objects through above-mentioned processes, since the anti-transparency agent is added to the thermoplastic synthetic resin of the intermediate layer 3 of the mark 5, there is no fear that any design or the like of the user's uniform or the objects in shape is observed from outside. More specifically, the anti-transparency agent added to the intermediate layer 3 of the mark 5 is effective to prevent the design or the like of the user's uniform or like objects in shape from being observed from outside even when the design or the like of the user's uniform or like objects is dyed using the sublimation type pigment and the pigment sublimates in use. Due to the presence of the anti-transparency agent in the intermediate layer 3 of the mark 5, there is no fear that the mark 5 of the present invention is discolored in use even when the design of the user's uniform or like objects is discolored due to sublimation of the pigment used in the user's uniform or like objects which the user has selected in use.

Since the mark 5 of the present invention has the above construction, it is possible for the mark 5 to have its base sheet 1 made of a non-woven fabric or the like which is poor in printability in the ink-jet or the ink-ribbon printing system, whereby the mark 5 becomes durable and excellent in printability in the ink-jet or the ink-ribbon printing system.

In use, even after application of the mark 5 onto the user's uniform or like objects, it is possible, if necessary, for the user to neatly peel off the mark 5 from his or her uniform or like objects by supplying a release agent to the mark 5 from the side of the uniform or like objects. The thus supplied release agent enters the adhesive layer 4 of the mark 5 to remove any anchorage effect of the adhesive layer 4 on the cloth of the user's uniform or like objects. This enables the user to neatly peel off the mark 5 from the cloth of his or her uniform or like objects.

On the other hand, the release agent thus supplied to the mark 5 from the side of the user's uniform or like objects does not remove any anchorage effect of the adhesive layer 4 on the intermediate layer 3 since both the base sheet 1 made of the non-woven fabric or the like and the intermediate layer 3 are entirely free from any effect of the release agent. Due to this, it is possible for the user to neatly peel off the mark 5 together with its adhesive layer 4 from the cloth of his or her uniform or like objects without any fear that the base sheet 1 of the mark 5 is separated from the intermediate layer 3.

Finally, the present application claims the Convention Priority based on Japanese Patent Application No. 2004-340182 filed on Nov. 25, 2004, which is herein incorporated by reference.

What is claimed is:

1. A hot press-bonding mark (5) having a construction characterized in that: said mark (5) is provided with a base sheet (1) made of a non-woven fabric, a taffeta, a spongy material or the like; a thin film of a thermoplastic synthetic resin excellent in printability in an ink-jet printing system or in an ink-ribbon printing system is formed in one of opposite surfaces of said base sheet (1); an intermediate layer (3) constructed of a thin film of a thermoplastic synthetic resin which does not react on any release agent is formed in the other of said opposite surfaces of said base sheet (1) to leave the other of opposite surfaces of said intermediate layer (3) alone; and, an adhesive layer (4) comprising a hot-melt based thermoplastic synthetic resin is formed in the thus left-alone one of said opposite surfaces of said intermediate layer (3).
